(19) United States
(12) Patent Application Publication
(10) Pub. No.: US 2024/0089001 A1
(43) Pub. Date: Mar. 14, 2024

(54) Systems and Methods for Transmitting and Receiving Wavelength-Multiplexed Optical Signals

(71) Applicant: The Regents of the University of California, Oakland, CA (US)

(72) Inventors: Clint Schow, Santa Barbara, CA (US); James Buckwalter, Santa Barbara, CA (US); Aaron Maharry, Goleta, CA (US); Hector Andrade, Goleta, CA (US); Larry Coldren, Santa Barbara, CA (US)

(73) Assignee: The Regents of the University of California, Oakland, CA (US)

(21) Appl. No.: 18/466,608

(22) Filed: Sep. 13, 2023

Related U.S. Application Data
(60) Provisional application No. 63/375,517, filed on Sep. 13, 2022.

(51) Int. Cl. H04B 10/40; G02F 1/01; G02F 1/21; G02F 3/00; H04B 10/516; H04B 10/61; H04J 14/02

(52) U.S. Cl. CPC H04B 10/40; G02F 1/0136; G02F 1/212; G02F 3/00; H04B 10/516; H04B 10/61; H04J 14/02; G02F 2201/02; G02F 2203/50

(57) ABSTRACT

Systems and methods for fabricating an optoelectronic transceiver with a tunable traveling wave modulator and an analog coherent receiver to transmit and receive wavelength-multiplexed optical signals in accordance with embodiments of the invention are disclosed. In one embodiment, a network switch includes a plurality of ports configured to transmit and receive optical signals and electrical current signals, a plurality of optoelectronic transmitters using a traveling wave modulator and driver biasing, and a plurality of analog coherent receivers.

### CROSS-REFERENCE TO RELATED APPLICATIONS

The current application claims the benefit of and priority under 35 U.S.C. § 119(e) to U.S. Provisional Patent Application No. 63/375,517 entitled “Systems and Methods for Transmitting and Receiving Wavelength-Multiplexed Optical Signals” filed Sep. 13, 2022. The disclosure of U.S. Provisional Patent Application No. 63/375,517 is hereby incorporated by reference in its entirety for all purposes.

### STATEMENT OF FEDERAL SUPPORT

This invention was made with government support under Grant No. DE-AR0000848 awarded by the Department of Energy. The government has certain rights in the invention.

### FIELD OF THE INVENTION

The present invention relates to transceiver integrated circuits for optoelectronic signals.

### BACKGROUND

Fiber-optic communication involves transmitting information from one point to another by sending pulses of light through a fiber optic link. The transmitted light can be in the form of a carrier signal that is modulated to carry information. Fiber-optic communication can transmit voice and video data across both short and long distances.

Integrated circuits (ICs) result from the integration of sets of electronic circuits into one small piece of semiconductor material. ICs are vastly more efficient and less expensive compared to the equivalent discrete electronic components that are built into them. Various functionalities, including integrated optical transceivers that combine optical devices with complementary metal-oxide semiconductor (CMOS) based electronics, have been successfully fabricated onto ICs.

### SUMMARY OF INVENTION

Systems and methods for fabricating an optoelectronic transceiver with a tunable traveling wave modulator and an analog coherent receiver to transmit and receive wavelength-multiplexed optical signals in accordance with embodiments of the invention are disclosed. In one embodiment, a network switch includes a plurality of ports configured to transmit and receive optical signals and electrical current signals, and a plurality of optoelectronic transmitters using a traveling wave modulator and driver biasing, each transmitter including: a traveling wave Mach-Zehnder modulator configured to modulate both amplitude and phase of optical signals to be transmitted, a set of one or more drivers configured to drive the modulator, further including a set of one or more electrical amplifiers configured to amplify input data signals, a set of one or more phase shifters within the modulator configured to add low-frequency marker tones to specific polarizations and in-phase or quadrature data channels, a set of one or more optical amplifiers configured to amplify modulated signals, a set of one or more optical wavelength multiplexers configured to multiplex optical signals of a plurality of polarizations, and a polarization beam combiner configured to combine the optical signals for transmission. The network switch further includes a plurality of analog coherent receivers, each receiver including: a polarization splitter rotator configured to separate orthogonal received polarization components, a polarization controller capable of continued reset-free recovery of the transmitted polarization channels, a local oscillator configured to output an unmodulated signal corresponding to the received signals, a hybrid configured to add the local oscillator output to the received optical signals in a proper relative phase, a set of one or more photodiodes configured to mix and detect the received optical signals, and generates downconverted electrical current signals, a set of one or more transimpedance amplifiers and limiting amplifiers configured to amplify the electrical signals, a phase-frequency detector configured to detect phase errors between the received signals and the signal output by the local oscillator, a set of one or more low-pass or band-pass filters configured to extract polarization marker tones from the transmitted signals, and a polarization control logic circuit configured to use feedback from the received polarization marker tones to tune the polarization controller and recover the transmitted polarization channels.

In another embodiment, the network switch further includes a load resistor in the driver having a value larger than a modulator impedance to simultaneously reduce power dissipation and minimize impedance mismatch penalty.

In a further embodiment, the traveling wave modulator includes a set of one or more distributed junction bias decoupling capacitors.

In still another embodiment, the input signal and local oscillator signal are transmitted and co-propagate on orthogonal polarizations on an optical fiber, wherein one polarization channel is used for data transmission, and the other polarization channel is used for local oscillator transmission.

In a still further embodiment, the input signal and local oscillator signal are transmitted and propagate on two parallel optical fibers, wherein one fiber is used for data transmission, and the other fiber is used for local oscillator transmission.

In yet another embodiment, the received signal and local oscillator signal are transmitted and co-propagate on orthogonal polarizations on an optical fiber, wherein one polarization channel is used for data transmission, and the other polarization channel is used for local oscillator transmission.

In a yet further embodiment, the received signal and local oscillator signal are transmitted and propagate on two parallel optical fibers, wherein one fiber is used for data transmission, and the other fiber is used for local oscillator transmission.

In another additional embodiment, the transmitter and receiver are implemented on a type of integrated circuit selected from the group consisting of a monolithic electronic and photonic integrated circuit, and a separate electronic and photonic integrated circuit.

One embodiment includes an optoelectronic transmitter including: a traveling wave Mach-Zehnder modulator configured to modulate both amplitude and phase of optical signals to be transmitted, a set of one or more drivers configured to drive the modulator, further including a set of one or more electrical amplifiers configured to amplify input data signals, a set of one or more phase shifters within the modulator configured to add low-frequency marker tones to specific polarizations and in-phase or quadrature data channels, a set of one or more optical amplifiers configured to amplify modulated signals, a set of one or more optical wavelength multiplexers configured to multiplex optical signals of a plurality of polarizations, and a polarization beam combiner configured to combine the optical signals for transmission.

One embodiment includes an analog coherent receiver including: a polarization splitter rotator configured to separate orthogonal received polarization components, a polarization controller capable of continued reset-free recovery of the transmitted polarization channels, a local oscillator configured to output an unmodulated signal corresponding to the received signals, a hybrid configured to add the local oscillator output to the received optical signals in a proper relative phase, a set of one or more photodiodes configured to mix and detect the received optical signals, and generates downconverted electrical current signals, a set of one or more transimpedance amplifiers and limiting amplifiers configured to amplify the electrical signals, a phase-frequency detector configured to detect phase errors between the received signals and the signal output by the local oscillator, a set of one or more low-pass or band-pass filters configured to extract polarization marker tones from the transmitted signals, and a polarization control logic circuit configured to use feedback from the received polarization marker tones to tune the polarization controller and recover the transmitted polarization channels.

Additional embodiments and features are set forth in part in the description that follows, and in part will become apparent to those skilled in the art upon examination of the specification or may be learned by the practice of the invention. A further understanding of the nature and advantages of the present invention may be realized by reference to the remaining portions of the specification and the drawings, which form a part of this disclosure.

### BRIEF DESCRIPTION OF THE DRAWINGS

The description and claims will be more fully understood with reference to the following figures and data graphs, which are presented as exemplary embodiments of the invention and should not be construed as a complete recitation of the scope of the invention.

FIGS. 1A-B illustrate two driver configurations for biasing a traveling wave Mach-Zehnder modulator (TW-MZM) in accordance with an embodiment of the invention.

FIG. 2 illustrates a cascode TW-MZM driver circuit in accordance with an embodiment of the invention.

FIG. 3 illustrates a simulated post-layout differential gain and group delay frequency response at the TW-MZM input in accordance with an embodiment of the invention.

FIGS. 4A-B illustrate a simulated transmitter electro-optic bandwidth and group delay variation in accordance with an embodiment of the invention.

FIG. 5 illustrates a calculated reflection coefficient (Γ) versus the output stage power consumption for various differential voltage swings (V_{sd}) in accordance with an embodiment of the invention.

FIG. 6 illustrates a circuit schematic of a differential MZM with a GSGSG differential co-planar waveguide-based modulator transmission line in accordance with an embodiment of the invention.

FIG. 7 illustrates a distributed transmission line circuit model for one arm of a differential MZM with junction and termination decoupling in accordance with an embodiment of the invention.

FIG. 8 illustrates a traveling-wave modulator integrated with the output stage of a driver circuit in accordance with an embodiment of the invention.

FIGS. 9A-B illustrate two implementations of an optoelectronic transmitter architecture for different coherent transmission schemes in accordance with an embodiment of the invention.

FIGS. 10A-D illustrate a Type 1 analog coherent receiver (ACR) in accordance with an embodiment of the invention.

FIGS. 11A-D illustrate a Type 2 ACR in accordance with an embodiment of the invention.

FIGS. 12A-B illustrate a transimpedance amplifier half-circuit consisting of an inverter and a pseudo-differential cascode amplifier, and an emitter-coupled differential pair limiting amplifier and 50Ω output buffer amplifier respectively, in accordance with an embodiment of the invention.

FIGS. 13A-B illustrate the block diagrams of a type 1 and a type 2 ACR respectively in accordance with an embodiment of the invention.

FIGS. 14A-B illustrate the circuit schematics of a Gilbert cell and a differential to single-ended amplifier respectively in accordance with an embodiment of the invention.

FIG. 15 illustrates a circuit schematic of a two-stage LF Op-Amp in accordance with an embodiment of the invention.

FIG. 16 illustrates an optical receiver block diagram of a photonic integrated circuit (PIC) and an electronic integrated circuit (EIC) in accordance with an embodiment of the invention.

FIG. 17 illustrates a fabricated wirebonded EIC driver assembly on a PCB in accordance with an embodiment of the invention.

FIG. 18 illustrates a summary of state-of-the-art TW-MZM drivers.

FIG. 19 illustrates a receiver assembly on a PCB in accordance with an embodiment of the invention.

FIG. 20 illustrates a self-homodyne test setup used in accordance with an embodiment of the invention.

FIG. 21 illustrates a block diagram of a network switch incorporating an optoelectronic transmitter and an analog coherent receiver in accordance with an embodiment of the invention.

### DETAILED DESCRIPTION

Intra-datacenter traffic has grown over 23% annually over recent years, placing increasingly stringent cost and power consumption requirements on optical links, which has created a need for optical links that are power-efficient and have the ability to provide high-speed data transfer over long distances. As both the start and end point in fiber-optic communications, optoelectronic transceivers can increase the efficiency of fiber-optic communications. An optoelectronic transceiver can convert optical signals received at its receiver component to electrical signals, and convert electrical signals to optical signals for transmission at its transmitter component. An optoelectronic transceiver may vary in size depending on its form factor, which is largely dictated by the type of data transmitted, as well as the speed and distance required for the transmission.

Current optoelectronic transmitters are limited in different ways depending on how they are fabricated. Many optoelectronic transmitters are fabricated based on narrow-band ring-resonator modulators, which can be very sensitive to process and temperature variations compared to Mach-Zehnder modulators (MZMs). Transmitters based on segmented MZMs (SEG-MZMs) have exhibited lower insertion loss compared to unamplified traveling-wave MZMs (TW-MZMs), but the packaging complexity of SEG-MZMs can be significantly higher due to SEG-MZMs being implemented using hybrid integration. On the other hand, while the packaging complexity of transmitters based on SEG-MZMs could be reduced by using a monolithic integration, the power dissipation of transmitters based on SEG-MZMs may be significantly higher than the power dissipation of TW-MZMs, with TW-MZMs still being able to achieve the required optical output power. Additionally, for modulators that use PN junction phase shifters, the junction bias voltage is a key design parameter that affects the bandwidth, modulation efficiency, and optical loss of the modulator. Current modulators, however, have restricted junction bias options because the modulator and driver are direct current (DC) coupled, and the modulator junction bias is set by the driver's DC output voltage.

Selecting an appropriate modulation scheme for data transmission can contribute greatly to transmission efficiency, but the selection can be highly dependent on the scalability of the optical links. Analog coherent detection (ACD) has demonstrated its ability to scale intra-datacenter intensity-modulation direct detection (IMDD) links beyond 100 Gb/s. To facilitate links based on ACD, dual polarization quadrature phase shift keying (DP-QPSK) can be used as a modulation scheme for ACD. DP-QPSK can be advantageous in that it does not require highly linear electronics, resulting in significant power savings. Silicon photonics (SiPh) TW-MZMs may enable low energy-per-bit (EPB) operation in DP-QPSK links while minimizing fabrication costs.

On the receiver side, original band (O-band) coherent detection has important benefits for use in optical interconnects that are shorter than two kilometers. The energy efficiency of coherent optical links used within a data center can depend heavily on the receiver electronics. Coherent detection can achieve a higher link margin than the intensity-modulation direct-detection (IM-DD) schemes that are currently in use. The increase in link margin allows for more power efficient network architectures, such as those that utilize optical switching. Additionally, operating in the O-band can be advantageous in that the chromatic dispersion minimum of commercial single-mode fiber is located near 1310 nm, which can relax digital signal processing (DSP) requirements. Therefore, low-power O-band receivers are the more desired option to be used in next-generation coherent intra-datacenter inter-connects. CMOS-based receiver electronics consume significantly less power than those implemented in SiGe BiCMOS, and thus can be a suitable alternative.

Systems and methods in accordance with many embodiments of the invention can improve on the efficiency of both the transmitter and receiver elements in an optoelectronic transceiver by using a cascode topology in the transmitter. In many embodiments, the cascode topology drives a SiPh TW-MZM to generate DP-QPSK channels. In several embodiments, the receiver is designed for analog coherent intra-datacenter links and is implemented as a single-polarization O-band QPSK receiver that includes an electronic integrated circuit (EIC) and a photonic integrated circuit (PIC) fabricated in a CMOS process.

In many embodiments, a novel TW-MZM architecture decouples the modulator PN junction bias from the driver's DC output voltage while maintaining DC coupling between the driver and modulator. Either the anode or the cathode of the junction may be connected to the traveling wave transmission line signal electrodes, and the corresponding cathode or anode of the junction may be connected to the transmission line ground electrodes through one or more decoupling capacitors, and also directly connected to a separate DC supply. This architecture allows for adjusting the junction bias independently of either the signal or ground electrode DC voltage levels. It can also help avoid the junction bias voltage from appearing across the modulator or driver termination resistors, which would result in undesired power dissipation. Furthermore, in the architecture, a termination network can be included that prevents DC current from flowing directly from the MZM termination to the ground electrodes. This can help ensure that while the modulator transmission line is properly terminated to mitigate signal reflections, the voltage difference between the signal and ground electrodes does not appear across the termination resistors, which would also result in undesired power dissipation. The architecture can allow for the tuning of the signal electrode DC voltage and the driver DC output voltage, independent of the optical modulator performance.

### Optoelectronic Transmitter

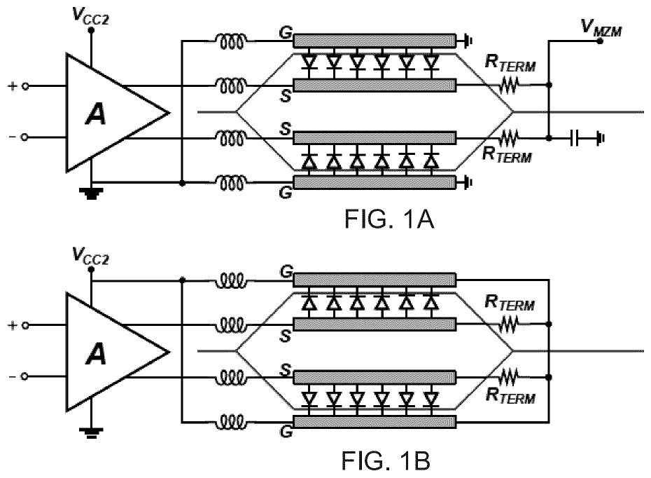

SiPh TW-MZMs are based on PN junction phase shifters that utilize the plasma dispersion effect, in which the carrier concentration, which depends on the electric field, changes the refractive index. The phase efficiency, the waveguide optical loss, and the PN junction capacitance all depend on the PN junction bias voltage. While the capacitance and optical loss may decrease with higher reverse bias, the phase efficiency may also decrease. FIGS. 1A-B illustrate two driver configurations for biasing the TW-MZM in accordance with an embodiment of the invention. In the configuration illustrated in FIG. 1A, the TW-MZM ground electrodes are connected to the driver ground node and the PN junction has a reverse bias of approximately 4V. In the configuration illustrated in FIG. 1b, the TW-MZM ground electrodes are connected to the voltage supply of the driver output stage and have a PN junction reverse bias of approximately 1V. Both configurations can enable even-mode termination, which extends down to DC in the 1 V configuration and has a low-frequency cutoff determined by on-chip and off-chip bypassing capacitors in the 4 V configuration.

Although specific examples of drivers are described above with reference to FIGS. 1A-B, any of a variety of driver configurations can be utilized to bias TW-MZMs similar to those described herein as appropriate to the requirements of specific applications in accordance with various embodiments of the invention.

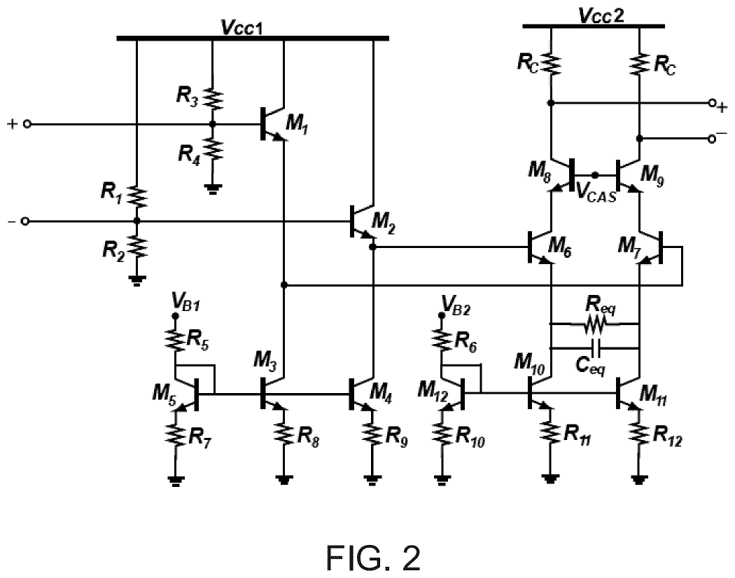

A cascode TW-MZM driver circuit in accordance with an embodiment of the invention is illustrated in FIG. 2. In numerous embodiments, the driver includes input 50Ω-matching emitter-followers and a cascode stage with supplies of 3 V and 5.8 V, respectively. In certain embodiments, the device lengths are 10 μm for M₁-M₄, 24 μm for M₆-M₁₁, and 2 μm for the current mirror devices M₅ and M₁₂. In many embodiments, emitter degeneration resistors R₇-R₁₂ are added to improve current matching and output resistance. Each of the load resistors (Rc) may be 130Ω in value. The cascode stage can allow for bandwidth extension by reducing the Miller capacitance while also increasing the output voltage swing. In selected embodiments, continuous-time linear equalization (CTLE) is implemented with Re q with a value of 3Ω, and C_{eq} with a value of 820 fF, which introduces a zero to add peaking at the expense of DC gain. The supplies V_{CC1} and V_{CC2} may be 3 V and 5.8 V respectively, and in many embodiments, the output DC voltage is 5V. The output stage can have a total current of 65 mA and is capable of producing 3 peak-to-peak voltage (Vₚₚ) of differential swing to a DC-coupled 30Ω TW-MZM, as shown in FIGS. 1A-B. In many embodiments, 30Ω was chosen because it is a typical single-ended impedance (60Ω differential) for SiPh TW-MZMs.

Although a specific example of a TW-MZM driver circuit is described above with reference to FIG. 2, any of a variety of driver circuits can be utilized to drive TW-MZMs similar to those described herein as appropriate to the requirements of specific applications in accordance with various embodiments of the invention.

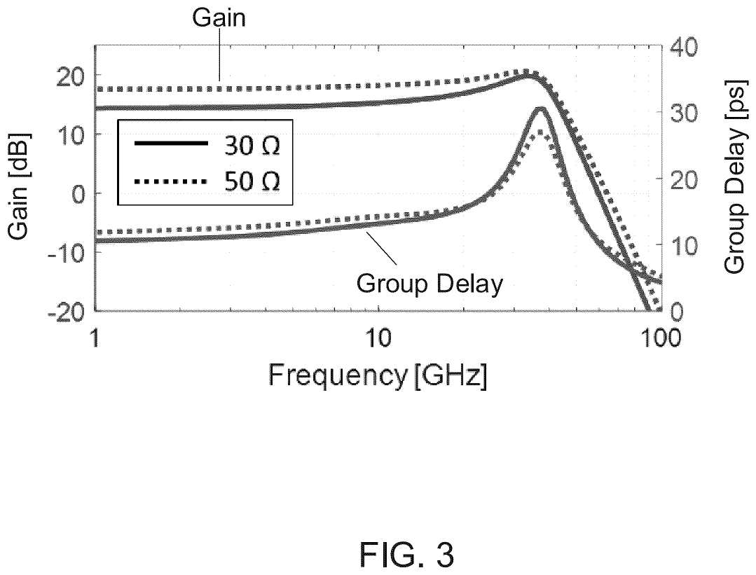

FIG. 3 illustrates the simulated post-layout differential gain and group delay frequency response at the TW-MZM input in accordance with an embodiment of the invention. The assumed bond pad capacitances are 15 fF and 25 fF for the driver and TW-MZM, respectively. The simulated wirebond inductance between the PCB and EIC (L_{bond,in}) is 200 pH and between the EIC and PIC (L_{bond,out}) it is 150 pH. When loaded with 50Ω, the driver has a differential midband gain of 17.7 dB and 3 dB of peaking. When the load is 30Ω, the gain is reduced to 14.5 dB, and the peaking increases to 5.4 dB, which also results in a larger group delay variation (GDV) by 3 ps when calculated up to 35 GHz.

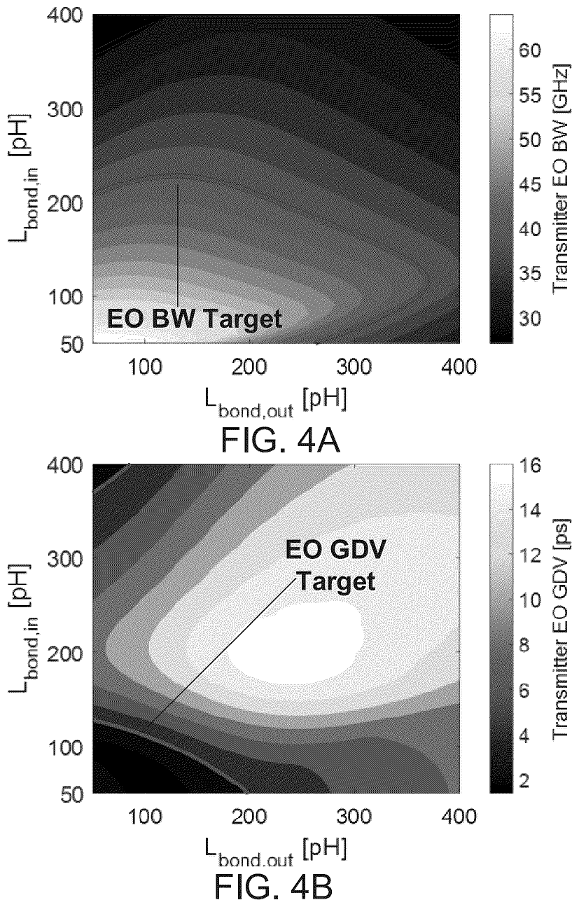

The packaging of the driver and TW-MZM can be important to achieve the target bit rate. Differences in die thicknesses of EICs and PICs, as well as the lateral separation between EICs and PICs on the PCB, can result in excessive wirebond inductance values for L_{bond,in} and L_{bond,out} when utilizing wirebond connections. FIGS. 4A-B illustrate the simulated TX electro-optic (EO) bandwidth (BW) and GDV, versus L_{bond,in} and L_{bond,out} in accordance with an embodiment of the invention. The EO BW of the standalone TW-MZM is assumed to be 25 GHz, which was simulated as a high-impedance first-order low-pass filter (LPF). The simulated TW-MZM input impedance (Zin) is 30Ω. The GDV was calculated up to 35 GHz, which is 62.5% of 56 Gb/s, and is a typical target BW at the transimpedance amplifier (TIA) output for the optimum compromise between inter-symbol interference (ISI) and noise power penalties. Typical targets for transmitter EO BW and GDV may be 40 GHz and 4 ps respectively as illustrated in FIGS. 4A-B. It can be observed that the GDV specification imposes a stricter constraint on the input and output wirebond inductances.

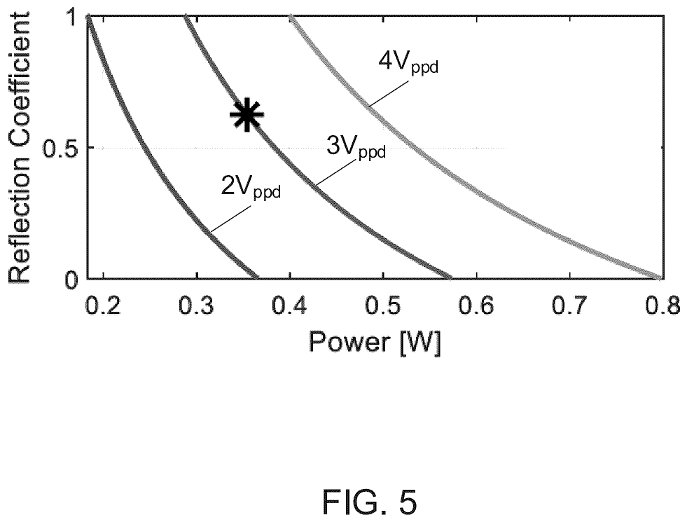

In some embodiments, a high-swing MZM driver can be designed by utilizing an open-collector (OC) output stage. An advantage of OC is that power consumption is minimized for a given voltage swing. However, one drawback of OC-based drivers can be that back-propagating waves may be entirely reflected at the driver output, which produces ISI. If the MZM termination (Rₜₑᵣₘ) is not matched to the transmission line, back-propagating waves may be produced at the impedance mismatch along the transmission line. For this reason, in many embodiments, a quasi-open-collector design implemented with 130Ω driver load resistors is utilized to design the high-swing MZM driver. This can reduce the reflection coefficient by 38% while increasing the power consumption of the output stage by less than 20%, and the total driver power by less than 15%. Moreover, decreased reflections can minimize the need for DSP, which can significantly reduce the power consumption of the optical link. FIG. 5 illustrates the calculated reflection coefficient (Γ) versus the output stage power consumption for various differential voltage swings (V_{sd}) in accordance with an embodiment of the invention, assuming Rₜₑᵣₘ˜|Z₀|. The power was calculated for the configuration shown in FIG. 1B, and assumed a 5 V driver output common-mode voltage (V_{cm}) and a TW-MZM ZO of 30Ω. At higher voltage swings, it becomes more power-demanding to reduce F. The power consumption of the output stage can be calculated by:

$$P = \frac{{V}_{sd} ( 4 {V}_{cm} + {V}_{sd} )}{8 ( {R}_{C} ‖ {R}_{term} )} \qquad ( 1 )$$

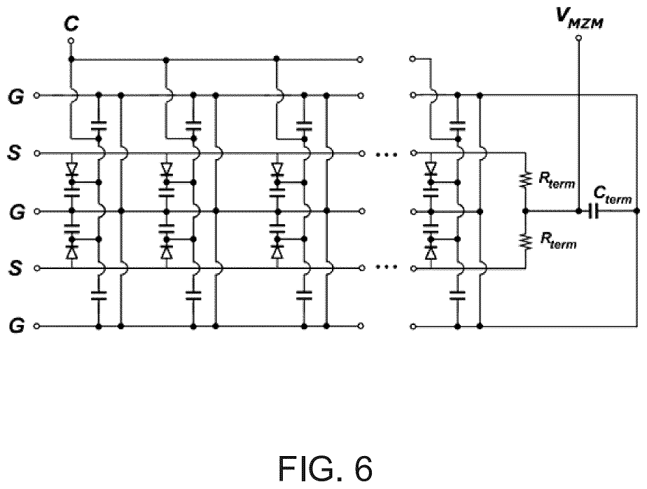

A circuit schematic of a differential MZM with a GSGSG differential co-planar waveguide-based modulator transmission line in accordance with an embodiment of the invention is illustrated in FIG. 6. In many embodiments, the modulator has distributed phased shifter decoupling and decoupled termination. In numerous embodiments, the signal electrodes contact the phase shifter anodes, and the phase shifter cathodes are decoupled to the ground electrodes and directly connected to the on-chip supply C. The phase shifter cathodes of each modulator or modulator arm may alternatively be connected to several different on-chip supplies, allowing for independent junction bias control between modulators or modulator arms on the same chip. At the termination, an on-chip supply V_{MZM} can be used to set the DC current across the termination resistors Rₜₑᵣₘ, and can be decoupled to the ground electrodes through the capacitor Cₜₑᵣₘ.

Although a specific example of MZM is described above with reference to FIG. 6, any of a variety of MZMs can be utilized to modulate optical signals similar to those described herein as appropriate to the requirements of specific applications in accordance with various embodiments of the invention.

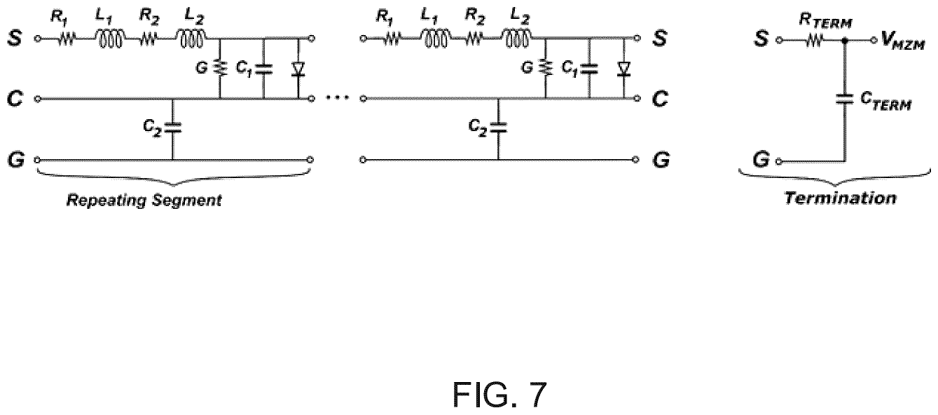

A distributed transmission line circuit model for one arm of a differential Mach-Zehnder modulator with junction and termination decoupling in accordance with an embodiment of the invention is illustrated in FIG. 7. Each segment is represented by resistors, capacitors, and inductors that can model the electrical performance of the transmission line electrodes, pn-juncton phase shifters, and decoupling network. R₁, L₁, G, and C₁ denote the RLGC parameters of the unloaded electrodes. Each phase shifter diode segment can be modeled as a junction resistance R₁ in series with a junction capacitance Cⱼ. C₂ represents the per-length decoupling capacitance from the phase shifter junction cathode to the ground electrode. If the modulator can be designed such that C₂» (C₁+Cⱼ), then the effect of the decoupled junction bias may be negligible on the high-speed modulator performance.

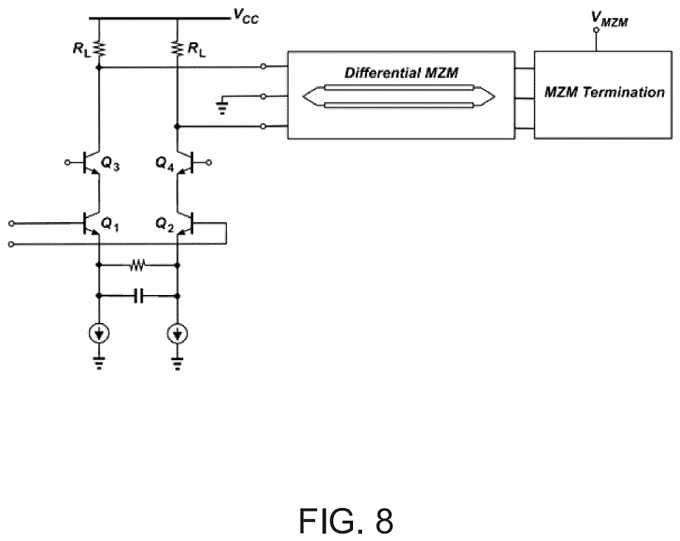

The power efficiency and performance of the integrated driver and modulator system can further be optimized with a quasi-open collector architecture. A traveling-wave modulator integrated with the output stage of a driver circuit in accordance with an embodiment of the invention is illustrated in FIG. 8. In several embodiments, the integrated circuit has a quasi-open-collector design, where the driver load resistance R_{L} may be tuned to be greater than the characteristic impedance or modulator termination resistance. This can allow for increased impedance mismatch between the modulator and driver at the cost of higher driver peak-to-peak voltage output and better power efficiency. As the driver output stage load resistance increases, a greater fraction of the driver output stage current may be sourced through the MZM termination through the V_{MZM} supply.

Although specific examples of integrated driver and modulator systems are described above with reference to FIG. 8, any of a variety of integrated systems can be utilized to modulate optical signals similar to those described herein as appropriate to the requirements of specific applications in accordance with various embodiments of the invention.

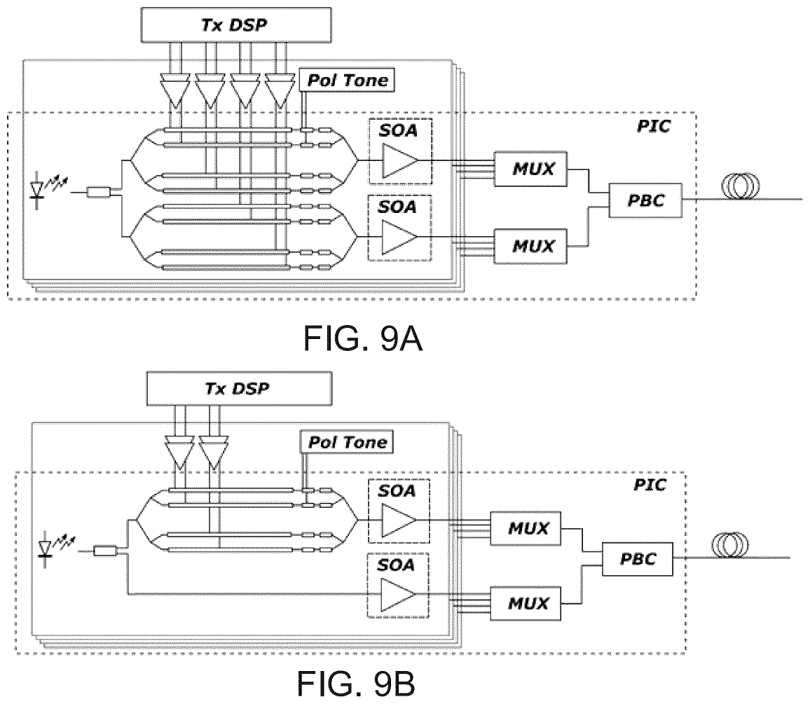

FIGS. 9A-B illustrate two implementations of the optoelectronic transmitter architecture for different coherent transmission schemes in accordance with an embodiment of the invention. FIG. 9A illustrates an implementation of an optoelectronic transmitter using traveling wave MZMs for dual-polarization coherent transmission with wavelength division multiplexing. FIG. 9B illustrates an implementation of an optoelectronic transmitter using traveling wave MZMs for signal-polarization transmission with wavelength division multiplexing for self-homodyne coherent detection architecture with the LO and TX signals co-propagating on the same fiber on orthogonal polarizations. In many embodiments, photonic components integrated on a PIC are based on a SiPh, indium phosphide (InP), lithium niobate, or other fabrication platform. The optoelectronic transmitter may be implemented with different combinations of integrated or discrete components.

In several embodiments, two differential MZMs are used in each polarization channel. Each arm of each differential MZM can have up to three or more electrically controlled optical phase shifters, one of which is a traveling-wave modulator for high-speed data modulation, one of which is a low-speed phase shifter for properly biasing each Mach-Zehnder interferometer (MZI), and one of which may be included to inject a polarization control tone into a desired signal channel. This polarization control tone signal is at a frequency much lower than the data modulation baudrate and serves to provide the optoelectronic receiver with information about the phase and state of polarization of the incoming signal, which may be used to perform polarization and phase recovery. Optical amplifiers and optical wavelength multiplexers may be included after the modulator for each polarization prior to the polarization beam combiner, allowing photonic integration platforms with large waveguide birefringence to support this transmitter.

Although specific examples of optoelectronic transmitters are described above with reference to FIGS. 9A-B, any of a variety of optoelectronic transmitters can be utilized to transmit optical signals similar to those described herein as appropriate to the requirements of specific applications in accordance with various embodiments of the invention.

### Analog Coherent Receiver

The energy efficiency of coherent links to be used within the data center can depend heavily on the receiver electronics. A front-end TIA and limiting amplifiers (LA) implemented in a SiGe BiCMOS, with an assumed combined power consumption of 410 mW, can account for more than 40% of the total power consumption in analog coherent intra-datacenter links that employ SiPh. This percentage may increase to over 50% when indium-phosphide optics are utilized.

On the other hand, CMOS-based receiver electronics consume significantly less power than those implemented in SiGe BiCMOS, and thus can be a suitable alternative. Monolithic integration of SiPh devices with CMOS transistors can be leveraged to fabricate low-cost, mass-produced, and high-performance optical transceivers, for which low-power receiver topologies will be required. In many embodiments, a single-polarization O-band QPSK receiver is fabricated using an EIC fabricated in the GlobalFoundries 45RF-SOI 45 nm CMOS process and a PIC fabricated in the GF 9WG process. Experimental results demonstrate the operation of the receiver at up to 50 GBaud baud rate.

In numerous embodiments of the invention, the analog coherent receiver (ACR) component of the optoelectronic transceiver is designed to operate with a received signal that is made up of several wavelength-multiplexed optical carriers, each containing a phase-modulated (PM) optical signal. In some embodiments, the ACR is based on an optical phase-locked loop (OPLL), and receives a DP PM signal, such as a DP-QPSK signal in each wavelength λ. An ACR based on an OPLL may be referred to as a Type 1 ACR.

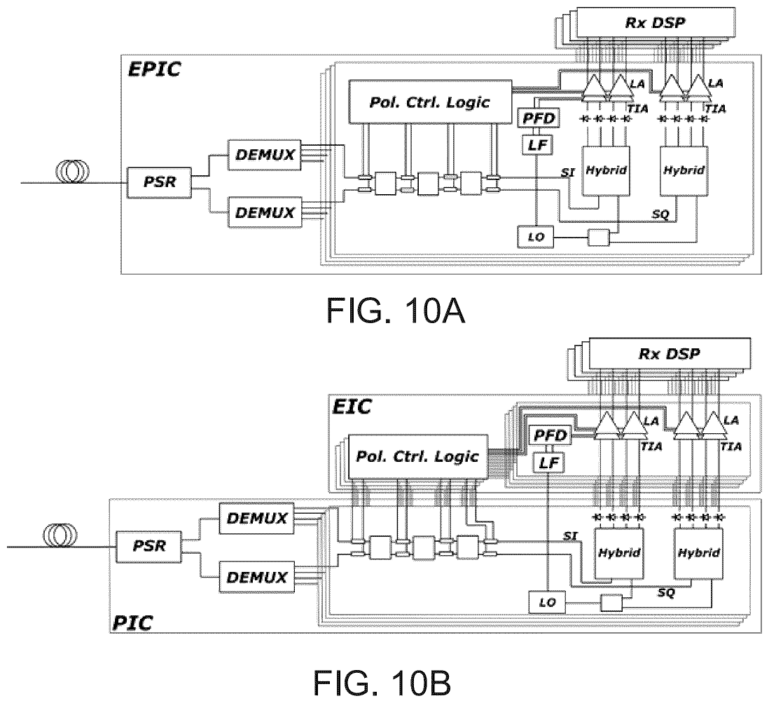

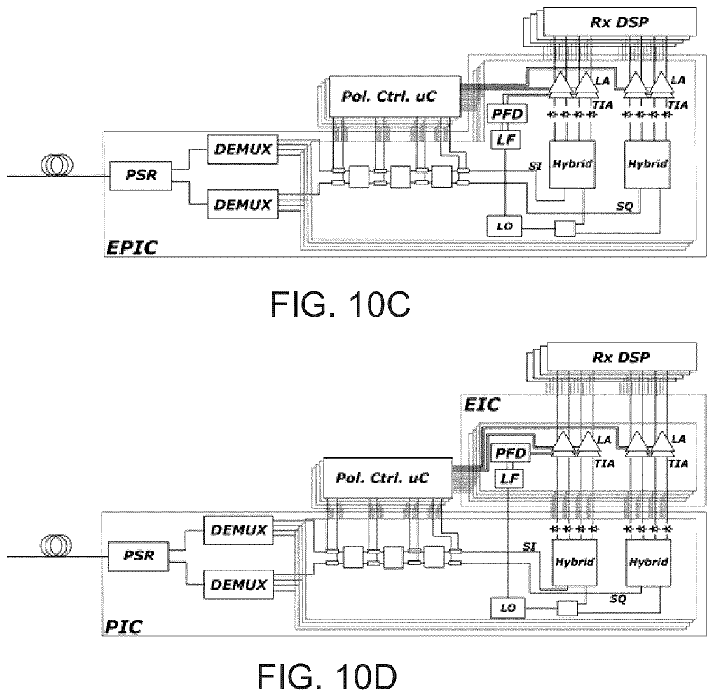

A Type 1 ACR in accordance with an embodiment of the invention is illustrated in FIGS. 10A-D. FIGS. 10A-B illustrate a type 1 ACR with four receiver slices under monolithic and hybrid implementations respectively with on-chip polarization control electronics. FIGS. 10C-D illustrate a type 1 ACR with four receiver slices under monolithic and hybrid implementations respectively, however with the polarization control microcontroller off-chip. The number of slices of receiver and the number of wavelengths that may be multiplexed and demultiplexed are not limited to four. A local oscillator laser (LO) can be located within the receiver, and the LO may be a tunable laser including but not limited to a distributed feedback laser (DFB), an external cavity laser (ECL), or a sampled grating distributed Bragg reflector laser (SGDBR).

In several embodiments, the ACR is based on a delay-locked loop (DLL), and receives a DP signal in each λ that carries a continuous-wave (CW) optical field in one polarization, and a PM signal, such as QPSK, in the other polarization. In selected embodiments of the DLL-based ACR, a DP-PM signal may be transmitted on one fiber and a CW signal on another fiber. An ACR based on a DLL may be referred to as a Type 2 ACR. The CW signal can serve as the receiver LO. The required tunable optical delay can be implemented with a heater or an electro-optic phase shifter, e.g., a PN junction phase shifter. In many embodiments, the received signal is coupled into the ACR, and a polarization splitter rotator (PSR) is used to demultiplex the two received polarizations. The PSR can be implemented with bulk optics or within a PIC. The various received wavelengths may then be demultiplexed. Wavelength demultiplexing can be done using bulk optics or within a PIC. On a PIC, the wavelength demultiplexer may be implemented using micro-ring resonators (MRR), MZI lattice filters, Echelle gratings, arrayed waveguide gratings (AWG), or integrated Bragg grating waveguides (IBG). For each demultiplexed wavelength, a polarization controller (PC) may be required to recover the original transmitted polarization. As the signal propagates along the fiber, it undergoes random time-varying polarization rotations, which need to be corrected for at the receiver. In many embodiments, low-pass filtered signals at the TIA outputs are directed to a controller, e.g., a microcontroller or FPGA, which adjusts pairs of heater-based phase shifters to minimize the pilot tone in the undesired channels to recover the original transmitter polarization.

The ACR implementation may be monolithic or hybrid. A monolithic ACR can be implemented on an electronic-photonic integrated circuit (EPIC). A hybrid ACR can be implemented by connecting an EIC and a PIC. The connections may be done through wirebonds or by flip-chip. The PIC may be fabricated on a material such as Silicon, InP or Gallium Arsenide (GaAs). In several embodiments, the electronics within the EPIC or EIC consist of high-frequency CMOS or bipolar devices. In numerous embodiments, one receiver slice is used for each corresponding received demultiplexed wavelength.

In many embodiments, the LO is phase-locked using an OPLL in a type 1 ACR. For each wavelength, each received polarization may be directed to an optical 90-degree hybrid. The LO can also be coupled into the 90-degree hybrid, which outputs the signals corresponding to the desired vectorial additions of the PM signal and the LO. In several embodiments, the output is routed to photodiodes (PDs) to convert the optical signal to an electrical current signal. TIAs and LAs may be used to convert the electrical current signal to a voltage signal. The OPLL can utilize a Costas Loop for carrier recovery and phase demodulation. In some embodiments, the Costas loop contains a phase-frequency detector (PFD) to detect the phase error between the LO and the carrier of the data signal, where the PFD consists of voltage mixers and a differential to single-ended amplifier. The output of the PFD can be directed to a loop filter, which outputs a signal to the tunable LO laser and can maintain the LO phase-locked to the received signal carrier.

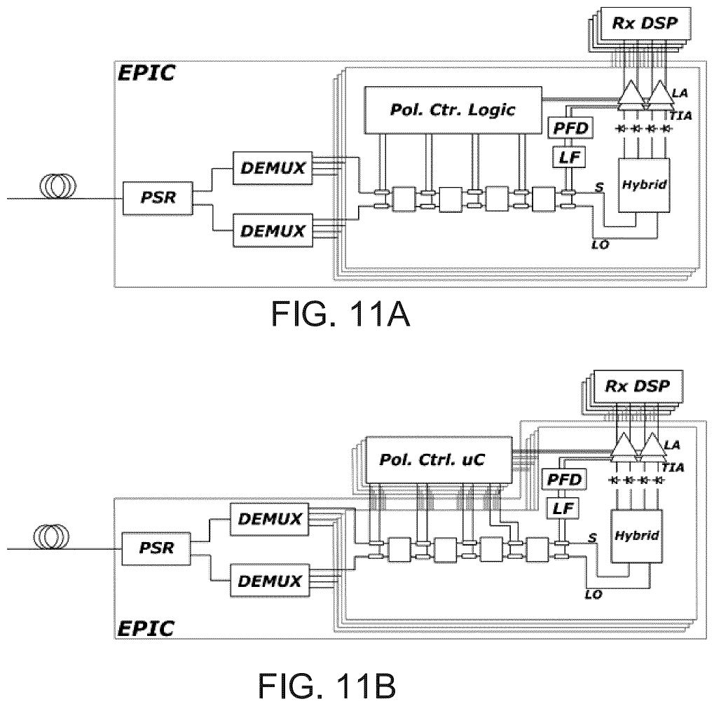

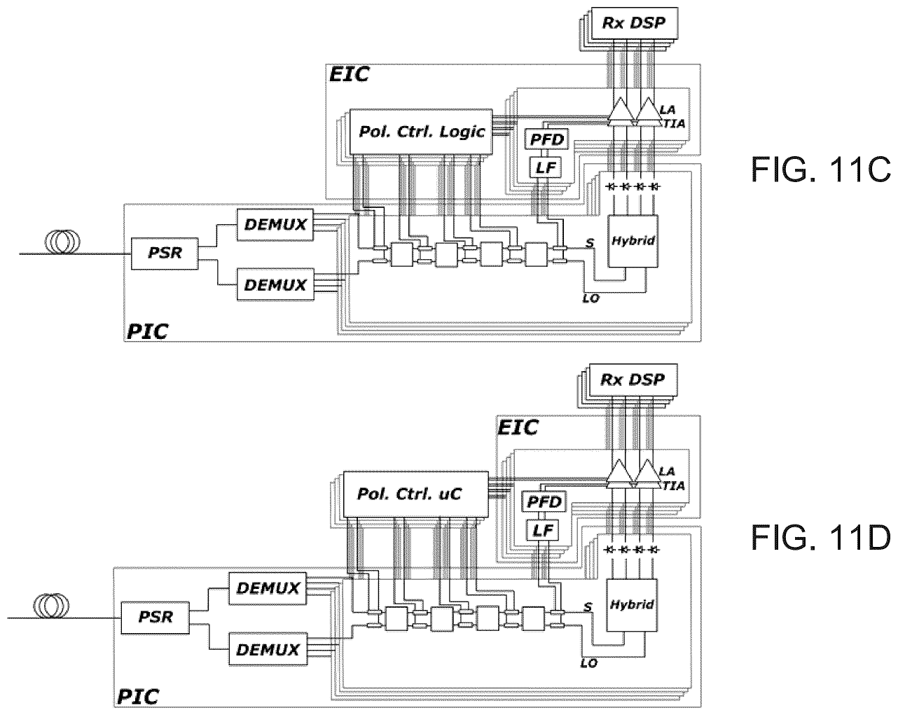

A Type 2 ACR in accordance with an embodiment of the invention is illustrated in FIGS. 11A-D. FIGS. 11A-B illustrate a type 2 ACR with four receiver slices under monolithic and hybrid implementations respectively with on-chip polarization control electronics. FIGS. 11C-D illustrate a type 2 ACR with four receiver slices under monolithic and hybrid implementations respectively, however with the polarization control microcontroller off-chip. The number of slices of the receiver and the number of wavelengths that may be multiplexed and demultiplexed are not limited to four.

In many embodiments, the LO in a type 2 receiver is contained in one of the two polarizations of the received signal. The LO may be phase-locked using an optical delay-locked loop (DLL). For each wavelength, the polarization that contains the PM and the LO polarization may both be directed to an optical 90-degree hybrid, which outputs the signals corresponding to the desired vectorial additions of the PM signal and the LO. In selected embodiments, the output is routed to PDs to convert the optical signal to an electrical current signal. TIAs and LAs may be used to convert the electrical current signal to a voltage signal. Similar to a type 1 ACR, the OPLL can utilize a Costas Loop for carrier recovery and phase demodulation. The Costas loop contains a PFD to detect the phase error between the LO and the carrier of the data signal. The PFD can include voltage mixers and a differential to single-ended amplifier. The output of the PFD may be directed to a loop filter, which outputs a signal to the tunable delay in the LO path, and maintains the LO phase-locked to the received signal carrier.

Although specific examples of ACRs are described above with reference to FIGS. 10-11, any of a variety of ACRs can be utilized to receive optical signals similar to those described herein as appropriate to the requirements of specific applications in accordance with various embodiments of the invention.

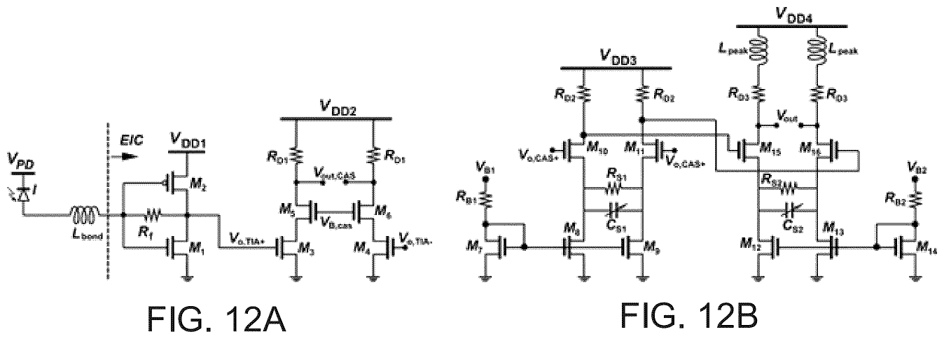

FIG. 12A illustrates a TIA half-circuit consisting of an inverter and a pseudo-differential cascode amplifier (CAS) in accordance with an embodiment of the invention. An inverter shunt-feedback TIA may be connected to each PD. The inverter topology combines both NMOS and PMOS transconductances, which can result in high gain at low power consumption, and the pseudodifferential configuration can save power by minimizing the voltage headroom. At the TIA output, a CAS can be used to raise the common-mode voltage to the required value for the subsequent source-coupled LAs.

FIG. 12B illustrates an emitter-coupled differential pair LA and 50Ω output buffer amplifier (OB) in accordance with an embodiment of the invention. Emitter-coupled amplifiers can be utilized for the LA and OB stages to provide common-mode rejection. In many embodiments, the LA chain includes six cascaded amplifiers of increasing transistor widths to minimize the loading between stages. R_{S} and varactor C_{S} can provide tunable equalization. In selected embodiments, the 50Ω OB has shunt inductive peaking, which can compensate for the output channel loss. In certain embodiments, the simulated post-layout 3 dB BW assuming a 40 GHz PD BW, including wirebonds and bondpad capacitances, is 23 GHz. In some embodiments, the simulated midband transimpedance is 55 dBΩ.

In numerous embodiments of the invention, electronics in the ACR are fabricated on a 45 nm silicon on insulator (SOI) CMOS process. The TIA can be an inverter and a pseudo-differential CAS. The LAs may be emitter-coupled differential pairs, and an OB which is matched to 50Ω at the output.

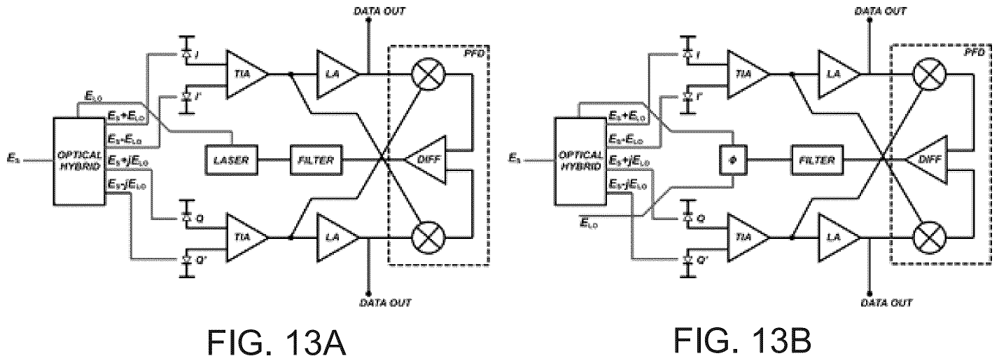

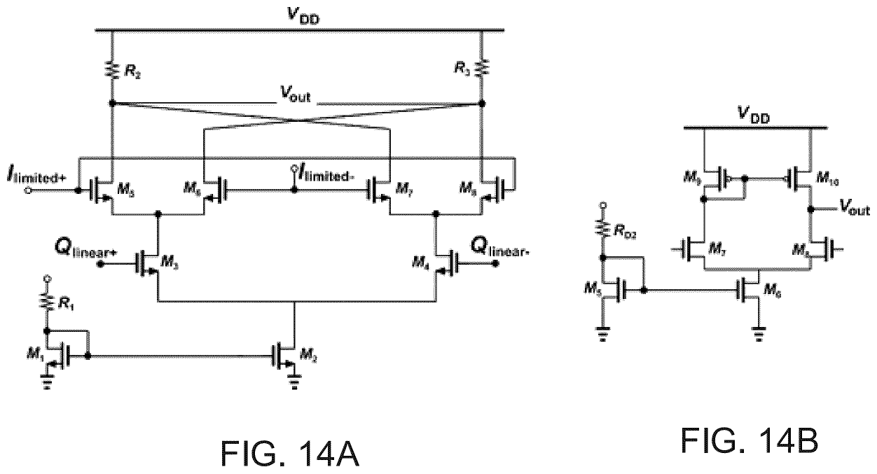

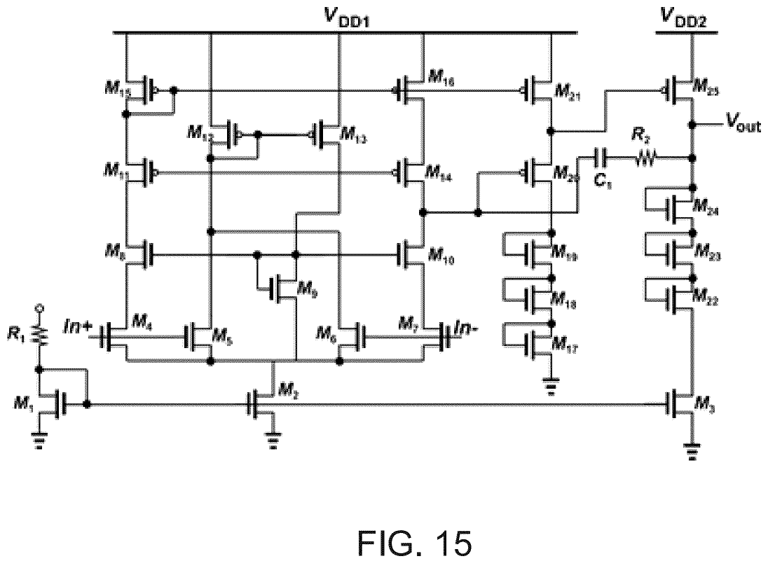

FIGS. 13A-B illustrate the block diagrams of a type 1 and type 2 ACR respectively in accordance with an embodiment of the invention. In many embodiments, the ACR is an optical QPSK Costas loop receiver designed for analog coherent intra-datacenter links. The PFD may include mixers and differential to single-ended amplifiers. The mixers may be implemented using Gilbert Cells and a differential to single-ended amplifier. FIGS. 14A-B illustrate the circuit schematics of a Gilbert cell and a differential to single-ended amplifier respectively in accordance with an embodiment of the invention. The loop filter may include a two-stage Op-Amp with off-chip resistors and capacitors, where the values of the resistors and capacitors determine the loop filter response, which typically is a proportional-integral or a purely integral controller. FIG. 15 illustrates a circuit schematic of a two-stage LF Op-Amp in accordance with an embodiment of the invention.

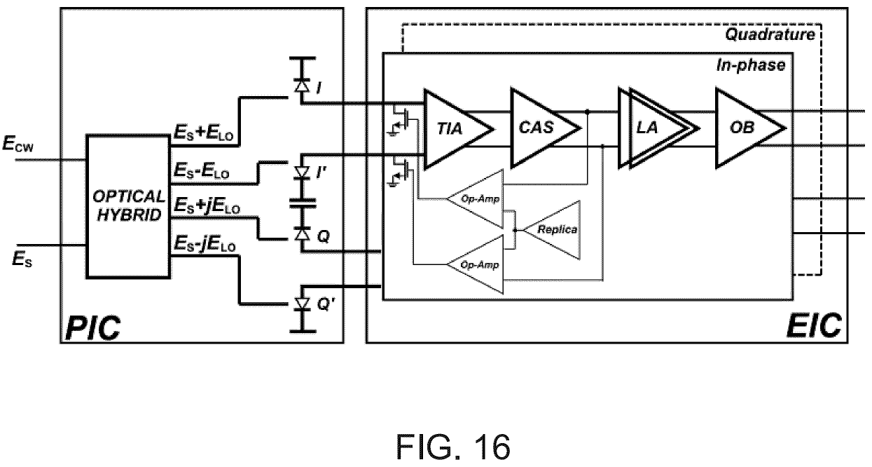

An optical receiver block diagram of the PIC and the EIC in accordance with an embodiment of the invention is illustrated in FIG. 16. The PIC may include an optical hybrid and 4 PDs, with the PD anodes connected via wirebonds to the TIA inputs of the EIC. In numerous embodiments, the optical hybrid receives a CW laser signal (E_{LO}) and a QPSK-modulated signal (E_{S}) and generates the four signals corresponding to the desired vectorial additions of the two input optical fields. The four generated signals can be routed to two pairs of balanced PDs, one for the in-phase (I) channel and the other for the quadrature channel (Q). In many embodiments, the electronics of the EIC include a TIA, a CAS, a cascade of LAs, and an OB. A slow loop based on a replica TIA and Op-Amps may be used for DC-offset compensation (DCOC) and to sink any excess DC photocurrent.

Although specific examples of circuit schematics are described above, any of a variety of circuits can be utilized to receive optical signals similar to those described herein as appropriate to the requirements of specific applications in accordance with various embodiments of the invention.

### Results

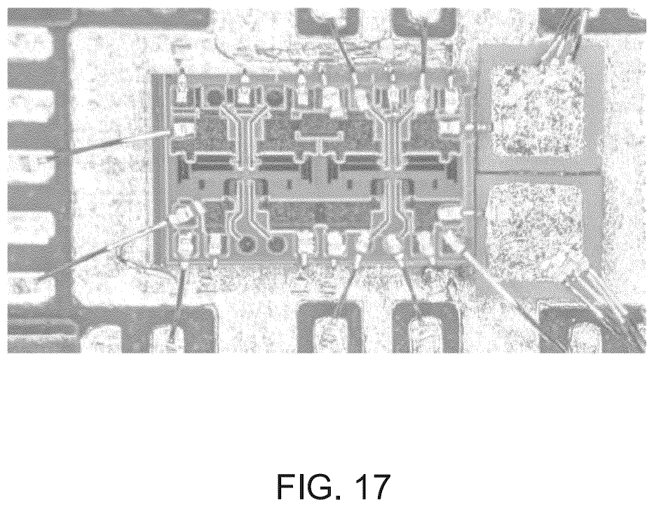

FIG. 17 illustrates a fabricated wirebonded EIC driver assembly on a PCB in accordance with an embodiment of the invention. The driver was fabricated in the GlobalFoundries 8XP 130 nm SiGe BiCMOS process. The die area is 1.23 mm×0.73 mm for a two-channel driver. The die thickness is 250 μm and the estimated length of the RF wirebonds is 320 μm. Off-chip 1.2 nF bypassing capacitors were added to V_{CC1} and V_{CC2}. Mini sub miniature push-on (SMP) RF connectors are utilized at the driver inputs and outputs. Bias-tees were used to AC-couple the 50Ω Tektronix sampling oscilloscope (SO) and to source current to emulate a DC-coupled TW-MZM. The signal was attenuated by 10 dB to operate within the SO limits.

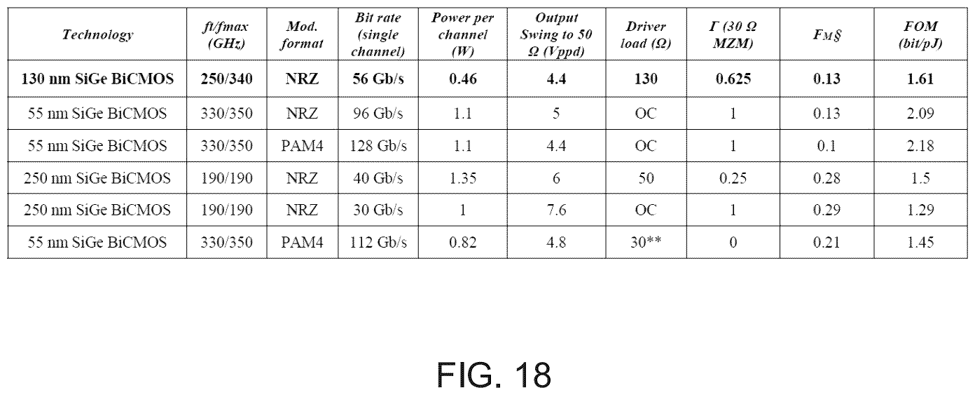

FIG. 18 illustrates a summary of state-of-the-art TW-MZM drivers, with the present invention represented in bold. The reflection coefficient for a 30Ω load is included, as this is a typical value for a SiPh TW-MZM. The modulation factor (FM) is calculated for a typical 3 mm SiPh TW-MZM with a V_{π}L of 19 V*mm. The FM indicates the modulation factor for a null-biased MZM. For a differential voltage swing of 2V_{π}, FM=1 and there is no modulation loss. If the voltage swing is decreased to V_{π}, FM=0.5. A figure-of-merit (FOM) is proposed as:

$$FOM = \frac{{A}_{MOD} B}{P} [ \frac{bit}{J} ] \qquad ( 2 )$$

where AMOD is the modulation gain of the TX, B is the bit rate, and P the power per driver channel. AMOD is the ratio of the FM with and without the driver for a 30Ω TW-MZM. The FM without the driver is calculated assuming the driver input swing (Vppd,in) is directly applied to the modulator, i.e., if the driver were removed from the TX. The Vppd,in was calculated from the small-signal gain, only in the case of the linear drivers indicated in FIG. 18, for which significant compression is not expected. The FOM is a measure of the driver gain, output swing, bandwidth, and power dissipation for a typical TW-MZM design. It also demonstrates the tradeoff associated with higher-order modulation formats, which enable higher bit rates at the cost of stricter linearity constraints, resulting in lower output voltage swings for a given power consumption. Our driver achieves a competitive FOM while maintaining a low r compared to open-collector designs.

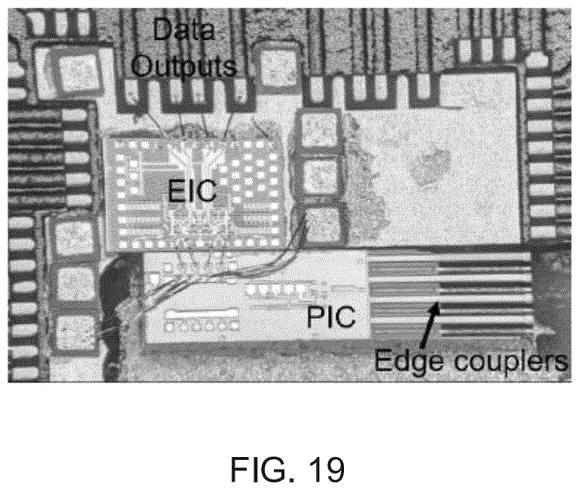

FIG. 19 illustrates the receiver assembly on a PCB in accordance with an embodiment of the invention. The EIC dimensions are 1.88 mm×1.28 mm and the PIC dimensions are 6 mm×1.1 mm. The PIC-to-EIC and EIC-to-PCB wirebonds are approximately 200 μm and 750 μm, respectively. Off-chip 1.2 nF bypassing capacitors were added to the PD and EIC supplies. Mini SMP RF connectors are used to measure the two differential data outputs. The measured power consumption of the EIC including the OB is 98 mW, or 0.98 pJ/bit for 50 GBaud QPSK transmission. If the OB is omitted, in case a 50Ω output is not required, the power is reduced to 77 mW, or 0.77 pJ/bit. The measured output noise of the EIC is 3 mV rms, the midband transimpedance is 477Ω, and the calculated input-referred noise is 6.3 μA rms.

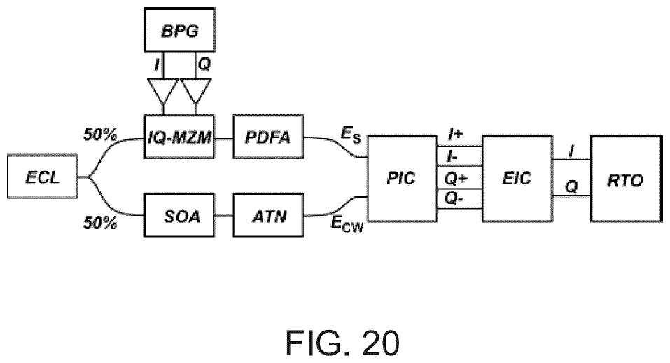

FIG. 20 illustrates the self-homodyne test setup used in accordance with an embodiment of the invention. An EXFO T100S-HP-O ECL set to 1310 nm and 13 dBm of power is connected to a 3 dB coupler. One coupler output is connected to an iXblue MXIQER-LN-30 IQ-MZM. Two channels of an SHF 12104A BPG are amplified and used to drive the IQ-MZM to generate the QPSK signal, which is then amplified using a praseodymium-doped fiber amplifier (PDFA) and edge-coupled to the PIC. The other output of the 3 dB coupler is amplified using a semiconductor optical amplifier (SOA) and then connected to an attenuator, the output of which is edge-coupled to the PIC. The EIC outputs are connected to a Keysight real-time oscilloscope (RTO) and the samples are compared to the PRBS sequence for error counting. The specified BW of the IQ-MZM is 25 GHz. To compensate for the IQ-MZM response, feed-forward equalization (FFE) was constructed using two outputs of the BPG with a coaxial power combiner.

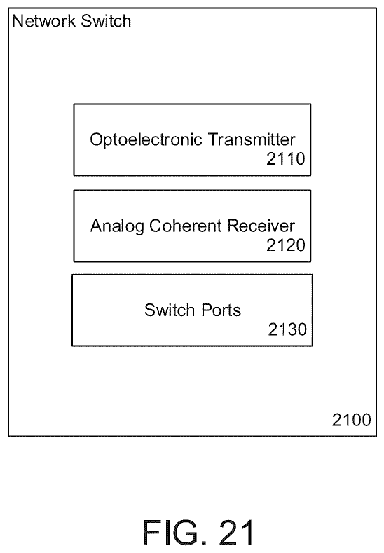

FIG. 21 illustrates a network switch incorporating an optoelectronic transmitter and an analog coherent receiver in accordance with an embodiment of the invention. The network switch may be an electrical network switch that can be used to perform electrical packet switching (EPS). In many embodiments, optical switch 2100 includes a plurality of optoelectronic transmitters 2110, a plurality of analog coherent receivers 2120, and a plurality of switch ports 2130. The plurality of optoelectronic transmitters and the plurality of analog coherent receivers may be fabricated as an optoelectronic transceiver on an application-specific integrated circuit (ASIC). The plurality of analog coherent receivers can receive an optical signal through each of the plurality of switch ports, and convert the received optical signal into an electrical current signal. The plurality of optoelectronic transmitters can convert an electrical current signal into an optical signal for transmission through the plurality of switch ports. In some embodiments, the optoelectronic transmitter and analog coherent receiver can be fabricated on a network interface card. In selected embodiments, the optoelectronic transmitter and analog coherent receiver can be fabricated and deployed in a data center.

Although specific methods of fabricating an optoelectronic transceiver with a tunable travelling wave modulator and an analog coherent receiver to transmit and receive wavelength-multiplexed optical signals are discussed above, many different methods can be implemented in accordance with many different embodiments of the invention. It is therefore to be understood that the present invention may be practiced in ways other than specifically described, without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

What is claimed is:

1. A network switch comprising:
a plurality of ports configured to transmit and receive optical signals and electrical current signals;
a plurality of optoelectronic transmitters using a traveling wave modulator and driver biasing, wherein each transmitter further comprises:
a traveling wave Mach-Zehnder modulator configured to modulate both amplitude and phase of optical signals to be transmitted;
a set of one or more drivers configured to drive the modulator, further comprising a set of one or more electrical amplifiers configured to amplify input data signals;
a set of one or more phase shifters within the modulator configured to add low-frequency marker tones to specific polarizations and in-phase or quadrature data channels;
a set of one or more optical amplifiers configured to amplify modulated signals;
a set of one or more optical wavelength multiplexers configured to multiplex optical signals of a plurality of polarizations; and
a polarization beam combiner configured to combine the optical signals for transmission; and
a plurality of analog coherent receivers, wherein each receiver further comprises:
a polarization splitter rotator configured to separate orthogonal received polarization components;
a polarization controller capable of continued reset-free recovery of the transmitted polarization channels;
a local oscillator configured to output an unmodulated signal corresponding to the received signals;
a hybrid configured to add the local oscillator output to the received optical signals in a proper relative phase;
a set of one or more photodiodes configured to mix and detect the received optical signals, and generate downconverted electrical current signals;
a set of one or more transimpedance amplifiers and limiting amplifiers configured to amplify the electrical signals;
a phase-frequency detector configured to detect phase errors between the received signals and the signal output by the local oscillator;
a set of one or more low-pass or band-pass filters configured to extract polarization marker tones from the transmitted signals; and
a polarization control logic circuit configured to use feedback from the received polarization marker tones to tune the polarization controller and recover the transmitted polarization channels.

2. The network switch of claim 1, further comprising a load resistor in the driver having a value larger than a modulator impedance to simultaneously reduce power dissipation and minimize impedance mismatch penalty.

3. The network switch of claim 1, wherein the traveling wave modulator includes a set of one or more distributed junction bias decoupling capacitors.

4. The network switch of claim 1, wherein the input signal and local oscillator signal are transmitted and co-propagate on orthogonal polarizations on an optical fiber, wherein one polarization channel is used for data transmission, and the other polarization channel is used for local oscillator transmission.

5. The network switch of claim 1, wherein the input signal and local oscillator signal are transmitted and propagate on two parallel optical fibers, wherein one fiber is used for data transmission, and the other fiber is used for local oscillator transmission.

6. The network switch of claim 1, wherein the received signal and local oscillator signal are transmitted and co-propagate on orthogonal polarizations on an optical fiber, wherein one polarization channel is used for data transmission, and the other polarization channel is used for local oscillator transmission.

7. The network switch of claim 1, wherein the received signal and local oscillator signal are transmitted and propagate on two parallel optical fibers, wherein one fiber is used for data transmission, and the other fiber is used for local oscillator transmission.

8. The network switch of claim 1, wherein the transmitter and receiver are implemented on a type of integrated circuit selected from the group consisting of:
a monolithic electronic and photonic integrated circuit; and
a separate electronic and photonic integrated circuit.

9. An optoelectronic transmitter using traveling wave modulator and driver biasing comprising:
a traveling wave Mach-Zehnder modulator configured to modulate both amplitude and phase of optical signals to be transmitted;
a set of one or more drivers configured to drive the modulator, further comprising a set of one or more electrical amplifiers configured to amplify input data signals;
a set of one or more phase shifters within the modulator configured to add low-frequency marker tones to specific polarizations and in-phase or quadrature data channels;
a set of one or more optical amplifiers configured to amplify modulated signals;
a set of one or more optical wavelength multiplexers configured to multiplex optical signals of a plurality of polarizations; and
a polarization beam combiner configured to combine the optical signals for transmission.

10. The transmitter of claim 9, further comprising a load resistor in the driver having a value larger than a modulator impedance to simultaneously reduce power dissipation and minimize impedance mismatch penalty.

11. The transmitter of claim 9, wherein the traveling wave modulator includes a set of one or more distributed junction bias decoupling capacitors.

12. The transmitter of claim 9, wherein the input signal and local oscillator signal are transmitted and co-propagate on orthogonal polarizations on an optical fiber, wherein one polarization channel is used for data transmission, and the other polarization channel is used for local oscillator transmission.

13. The transmitter of claim 9, wherein the input signal and local oscillator signal are transmitted and propagate on two parallel optical fibers, wherein one fiber is used for data transmission, and the other fiber is used for local oscillator transmission.

14. The transmitter of claim 9, where the transmitter is implemented on a type of integrated circuit selected from the group consisting of:
a monolithic electronic and photonic integrated circuit; and
a separate electronic and photonic integrated circuit.

15. An analog coherent receiver comprising:
a polarization splitter rotator configured to separate orthogonal received polarization components;
a polarization controller capable of continued reset-free recovery of transmitted polarization channels;
a local oscillator configured to output an unmodulated signal corresponding to the received signals;
a hybrid configured to add the local oscillator output to received optical signals in a proper relative phase;
a set of one or more photodiodes configured to mix and detect the received optical signals, and generates downconverted electrical current signals;
a set of one or more transimpedance amplifiers and limiting amplifiers configured to amplify the electrical signals;
a phase-frequency detector configured to detect phase errors between the received signals and the signal output by the local oscillator;
a set of one or more low-pass or band-pass filters configured to extract polarization marker tones from the transmitted signals; and
a polarization control logic circuit configured to use feedback from the received polarization marker tones to tune the polarization controller and recover the transmitted polarization channels.

16. The receiver of claim 15, wherein the local oscillator is phase-locked using an optical phase-locked loop.

17. The receiver of claim 15, wherein the local oscillator is phase-locked using an optical delay-locked loop.

18. The receiver of claim 15, wherein the received signal and local oscillator signal are transmitted and co-propagate on orthogonal polarizations on an optical fiber, wherein one polarization channel is used for data transmission, and the other polarization channel is used for local oscillator transmission.

19. The receiver of claim 15, wherein the received signal and local oscillator signal are transmitted and propagate on two parallel optical fibers, wherein one fiber is used for data transmission, and the other fiber is used for local oscillator transmission.

20. The receiver of claim 15, where the receiver is implemented on a type of integrated circuit selected from the group consisting of:
a monolithic electronic and photonic integrated circuit; and
a separate electronic and photonic integrated circuit.
